(19) United States
(12) Patent Application Publication
(10) Pub. No.: US 2011/0267417 A1
(43) Pub. Date: Nov. 3, 2011

(54) MOBILE TELEPHONE

(76) Inventors: Dirk Michelsen, Hamburg (DE); Bernd Baranski, Hamburg (DE)

(21) Appl. No.: 13/116,469

(22) Filed: May 26, 2011

Related U.S. Application Data
(63) Continuation of application No. PCT/EP2009/008388, filed on Nov. 25, 2009.

(30) Foreign Application Priority Data
Nov. 28, 2008 (DE) 10 2008 059 582.9

(51) Int. Cl. H04N 7/14; H04W 4/12; H04W 4/00

(52) U.S. Cl. 348/14.02; 455/414.1; 455/412.1; 348/E07.081

(57) ABSTRACT

A mobile telephone, having a camera function, wherein the mobile telephone is designed, on an existing voice connection of the mobile telephone to the opposite station of another remote conversation partner, to carry out taking an image by camera and wirelessly sending the same to a target address based on the call number for the other remote conversation partner used for the conversation, by means of operating at least one given operating element of the mobile telephone.

### CROSS-REFERENCE TO RELATED APPLICATION

This application is continuation of PCT Appln. No. PCT/EP2009/008388 filed Nov. 25, 2009, which claims priority to Germany application 10 2008 059 582.9 filed Nov. 28, 2008, the disclosures of which are incorporated in their entirety by reference herein.

(1) Mobile Telephone with a Camera Function

Most mobile telephones on the market at the moment have an integrated camera. The camera can be used to photograph images, and the images can be stored in the mobile telephones.

However, it is often difficult to use a mobile telephone to photograph images, since it is first of all necessary to use a menu to change from a telephone mode to a photography mode, in order subsequently to allow an image to be photographed and stored, by means of separate key operations.

With many mobile telephones, it is also possible to send photographed and/or stored images by means of the Multimedia Messaging Service (MMS) to another mobile telephone. In some cases, it is even possible to send stored images by E-mail.

However, if one wishes to send a photographed or stored image by MMS to another mobile telephone, an MMS send mode must first of all be entered with the aid of a menu. In the MMS send mode, a stored image can then be selected and associated with an MMS. The MMS can then be sent with the image via the air interface of the mobile telephone by means of a key operation.

The procedure described above for photographing and sending an image by MMS is, however, too difficult in most situations in which the normal user of a mobile telephone wishes to photograph an image and send it to another mobile telephone. For instance, it is often desirable to photograph an image and to send it to the call partner during an existing telephone call, for example in order to show a tourist attraction when on vacation, while shopping in order to check whether a specific product should be purchased, or during a party, in order to show who is there. The same problem also occurs in business situations in which someone wishes to show an object to a call subscriber, for example, when calling a customer hotline or in the event of a conversation relating to the quality of a product.

The invention is based on the object of providing a mobile telephone which allows an image to be photographed easily by a camera, with the photographed image subsequently being sent wirelessly to a destination address associated with another telephone subscriber.

In order to achieve this object, a mobile telephone with a camera function is provided, which is designed such that, when a voice link exists between the mobile telephone and a remote station of another telephone subscriber, a camera photograph of an image is taken, controlled by the operation of at least one predetermined control element on the telephone, and the photographed image is sent wirelessly to a destination address, which is associated with the other telephone subscriber and is determined on the basis of the telephone number used for the voice link to the other telephone subscriber.

The present invention is distinguished in that an image can be photographed and can be sent to a telephone subscriber in a simple manner, that is to say without having to select a multiplicity of menu options. In particular, operation of the predetermined control element during a voice link can result in an image being photographed and the image being dispatched wirelessly to the destination address of the other telephone subscriber during the voice link. This has the advantage that the other telephone subscriber can receive the photographed image while the voice link is in existence, and both telephone subscribers can discuss it.

The mobile telephone may be any type of communication apparatus which is equipped with a camera and is designed to send images photographed by the camera via an air interface. The control element may be a camera operating key or a key which is provided specifically for photographing with the camera and for sending, in particular on a touchpad. When using a camera operating key both for photographing and for sending the image, a key can be saved, since the camera operating key not only takes the photograph but also initiates the sending of the image to the destination address of the other telephone subscriber.

The mobile telephone is preferably designed to send the photographed image to the destination address while the voice link exists by means of a dispatch service for multimedia messages or by means of an E-mail service, and in this case to use the telephone number used for the voice link to the other telephone subscriber as the destination address for the multimedia message dispatch, or to use an E-mail address which is stored in an internal telephone directory in the telephone, associated with the telephone number used for the other telephone subscriber, for the E-mail dispatch. It is therefore possible to send a photographed image to a telephone subscriber without having to end a voice link which is in existence and without having to enter a telephone number or E-mail address. For example, a photographed image can be sent by just one key operation to the telephone subscriber to whom there is currently a voice link. The photographed image is preferably sent by E-mail when voice links exist to landline numbers.

In order to make it easier to photograph images while a voice link is in existence, the mobile telephone can be designed to display a viewfinder image in a display window while the voice link exists. The display window may be the display apparatus on the mobile telephone. For example, the user of the mobile telephone can use the camera to photograph an image, which is displayed in the display window on the mobile telephone, while the voice link is in existence, for example with the assistance of a hands-free function.

In order to make it easier to display images received during the existence of a voice link, the mobile telephone can be designed to automatically display a multimedia message, which has been received from the remote station during the existence of the voice link, on a display apparatus. This allows the user of the mobile telephone to avoid having to select a display option in a menu structure in order to display the multimedia message during an existing voice link, by means of which menu structure the multimedia message is reproduced in the display apparatus.

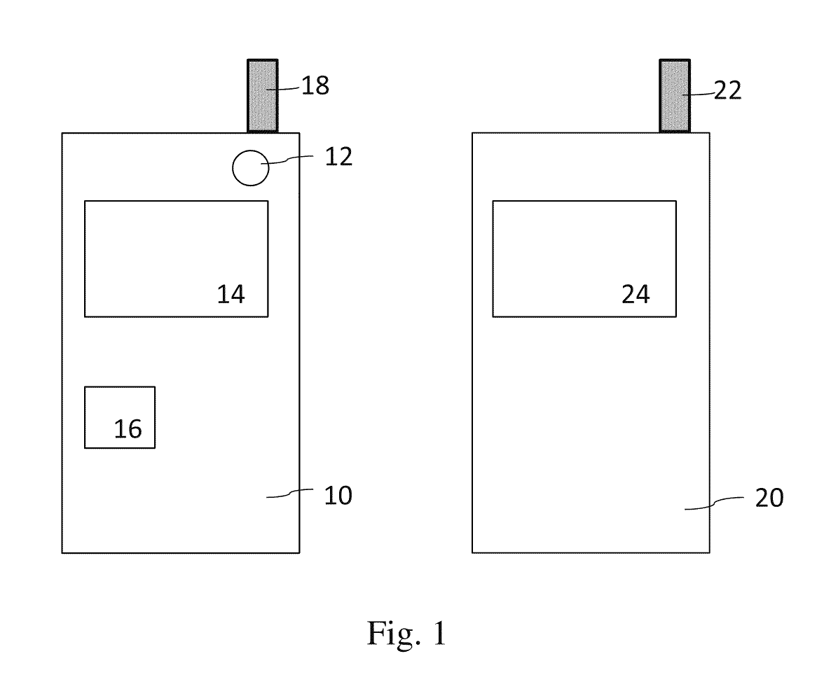

FIG. 1 shows a schematic illustration of an exemplary embodiment with two mobile telephones.

A first mobile telephone 10 contains a camera 12, a display apparatus 14 and a camera operating key 16. The mobile telephone 10 sets up a voice link to a further mobile telephone 20 via an antenna 18. The mobile telephone 20 communicates with the mobile telephone 10 via an antenna 22. Both mobile telephones 10 and 20 operate on the basis of the Universal Mobile Communications System (UMTS) standard. However, the invention is not restricted to the UMTS standard. By way of example, the mobile telephones 10, 20 may also be operable using the Global System for Mobile Communications (GMS), Enhanced Data Rates for GSM Evolution (EDGE) and/or Long Term Evolution (LTD) standards.

While the voice link is in existence between the mobile telephones 10 and 20, images photographed by the camera 12 are displayed on the display apparatus 14.

If the user of the mobile telephone 10 wishes to photograph an image and send this by MMS to the other mobile telephone 20 while the voice link is in existence, then he operates the camera operating key 16. This operation initiates a process in which the camera 12 photographs an image, and then compresses the image to a data format which can be used for MMS dispatch. In addition, the image can also be stored in the mobile telephone. Because of the existence of the voice link between the mobile telephones 10 and 20, the mobile telephone 10 knows the telephone number of the mobile telephone 20. In particular, the mobile telephone 10 obtains the telephone number of the mobile telephone 20 from the Call ID or the Call Status of the mobile telephone 20.

If the telephone number of the mobile telephone 20 is unknown or cannot be determined, then an error message is produced in the mobile telephone 10 and an input request to input a telephone number is displayed on the display apparatus 14. After inputting a telephone number, this is used to send the MMS.

If the telephone number of the mobile telephone 20 is known, or it has been possible to determine it, then a data channel is opened while the voice link is in existence, via which the MMS with the photographed image is sent to the mobile telephone 20.

In consequence, the key 16 need be operated only once to photograph an image with the aid of the camera 12, and to send the photographed image while a voice link is in existence.

The mobile telephone 20 is designed to receive the MMS sent from the mobile telephone 10, while the voice link is in existence. The mobile telephone 20 in this case recognizes that the MMS has been sent from the same telephone number as that of the current voice link. For this reason, the mobile telephone 20 displays the image on the display apparatus 24 immediately after receiving the MMS. After receiving the MMS, the image is automatically displayed on the display apparatus 24, without the user of the mobile telephone 20 having to operate a key. While the image is displayed, the voice link between the mobile telephones 10 and 20 continues.

Two separate keys, that is to say a camera operating key 16 for photographing an image and an additional key (not shown) for sending an MMS with the image during an existing voice link, can also be provided for the camera photograph and for MMS dispatch in the mobile telephone 10.

It is also feasible for an input request “send by MMS?” to be displayed on the display apparatus 14 during an existing voice link, when the camera operating key 16 is operated. As a response to the input request, the camera operating key 16, or some other key (not shown) can be operated again, to send the photographed image by MMS to the mobile telephone 20.

It is also feasible for it to be possible to photograph an image and to send the image by MMS by simultaneously pressing the camera operating key 16 and a further key (not shown).

The camera photography function and the dispatch of recorded images by MMS, and the MMS receive and display function can be implemented in the firmware in the mobile telephones 10 and 20.

In the exemplary embodiment of FIG. 1, the present invention was explained with reference to an MMS dispatch. An E-mail dispatch can correspondingly also be used, in addition to or instead of the MMS dispatch.

(2) Mobile Telephone with Video Call Camera Function

In principle, most third-generation mobile telephones, for example mobile telephones operating in accordance with the UMTS standard, have the capability to initiate voice calls and video calls. One disadvantage, however, is that the user of a mobile telephone such as this must decide when initiating the call whether he wishes to make a voice call or a video call. When a video call is being set up but no link is created, for example because the remote station does not or cannot accept the video call, then the caller can initiate a separate voice call. However, this procedure is difficult, because the user must manually initiate the respective calls.

The invention has the object of providing a mobile telephone which allows simple use of video calls.

In order to achieve this object, a mobile telephone having a video call camera function is provided, which is designed (i) in response to a voice call request entered by a user, to set up both a voice call and a video call to a destination telephone number predetermined by the voice call request, (ii) to receive information sent back from a remote station associated with the destination telephone number, in response to the voice call and video call, and to confirm the availability of the remote station for voice links and/or video telephone links on the basis of the received information, (iii) to clear the video call again, (iv) during the existence of a voice link which has been produced by acceptance of the voice call by the remote station, to set up a further video call to the destination telephone number in response to a predetermined user input, and (v) to clear the voice link in response to the acceptance of the further video call by the remote station.

It is therefore possible to check whether the remote station can in principle accept voice calls and/or video calls. For example, UMTS cards provided for laptop computers cannot accept voice calls. If the remote station is technically able to accept voice calls and video calls, then, according to the invention, it is possible to change to a video call link while a voice link is in existence. This is particularly advantageous since the desire to additionally transmit images or videos often occurs only during an existing voice link.

The mobile telephone is preferably designed to clear the video call without having to wait for acceptance of the video call by the remote station. By way of example, the video call can thus be cleared after a specific time period has elapsed if no link to the remote station has been made during this time.

In order to make it possible to change without any interruption from a voice call to a video call, or from a video call to a voice call, the mobile telephone can be designed to wait for acceptance of one of the two calls by the remote station, to clear the video call in response to acceptance of the voice call, and to clear the voice call in response to acceptance of the video call.

In order to allow a simple change to a video call while a voice call is in existence, the mobile telephone can be designed to display a menu option in a display window on the mobile telephone when a voice link exists, which menu option allows a change from the voice link to a video telephone link, with the menu option preferably being displayed as a function of the availability of the remote station for video telephone links having been confirmed. The user of the mobile telephone can therefore recognize in a simple manner, while a voice link is in existence, whether it is possible to change to a video telephone link.

In order to change from an existing video telephone link to a voice link, particularly if video transmission is no longer required, the mobile telephone can be designed to set up a further voice call to the destination telephone number, in response to a predetermined user input, during the existence of a video telephone link to the remote station, and to clear the video telephone link in response to the acceptance of the further voice call by the remote station.

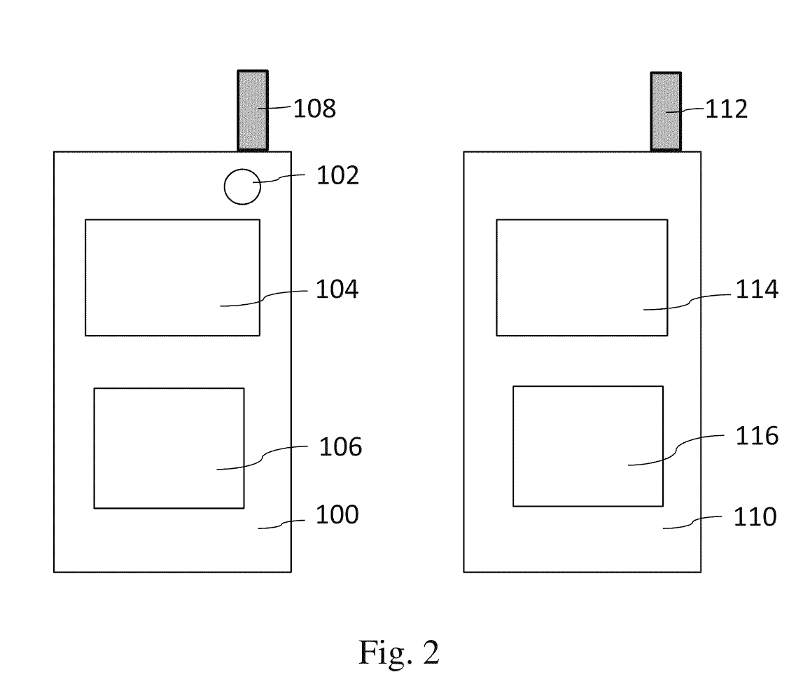

FIG. 2 shows a schematic illustration of one exemplary embodiment of two mobile telephones.

A first mobile telephone 100 comprises a camera 102, a display apparatus 104 and a keypad 106. The mobile telephone 100 can set up both a voice call and a video call to a further mobile telephone 110 via an antenna 108. The mobile telephone 110 comprises an antenna 112, a display apparatus 114, and a keypad 116. The mobile telephones 100 and 110 may be operable, for example, in accordance with GSM, EDGE, UMTS and/or LTE standards.

In order to set up a call, the user of the mobile telephone 100 uses the keypad 106 to enter the telephone number of the mobile telephone 110, and operates a call key. The mobile telephone 100 then sets up both a voice call and a video call to the mobile telephone 110. Both a voice call and a video call therefore arrive at the mobile telephone 110. The mobile telephone 110 then signals to the mobile telephone 100 whether it can technically in principle accept a voice call and/or a video call.

If the mobile telephone 110 cannot accept video calls, then the mobile telephone 100 clears the video call again. If the mobile telephone 110 cannot accept voice calls, then the mobile telephone 100 clears the voice call again. If the mobile telephone 110 is able to accept both voice calls and video calls, then it can decide which of the two calls it will accept, and signals the respective acceptance to the mobile telephone 100. By way of example, the display device 114 can display an input request to select a voice call link or video call link. If the mobile telephone 110 accepts the voice call, then it signals this choice to the mobile telephone 100, and the mobile telephone 100 clears the video call again. Correspondingly, if the mobile telephone 110 accepts the video call, then it signals this selection to the mobile telephone 100, with the mobile telephone 100 clearing the voice call again.

After initially setting up the voice and video calls, the mobile telephone 100 stores the types of calls that the mobile telephone 110 can accept, for subsequent calls.

When there is a voice link between the mobile telephones 100 and 110, then the display apparatus 104 on the mobile telephone 100 indicates whether it is possible to change to a video call link. If a change such as this is possible, then the process of setting up a video call can be initiated by key operation. As soon as a video call link exists between the two mobile telephones 100 and 110, the mobile telephone 100 once again clears the existing voice call between the mobile telephone 100 and 110. Correspondingly, during the video call, the display apparatus 104 on the mobile telephone 100 indicates whether it is possible to change from the video call to the voice call, that is to say a voice call can be set up in addition to the video call, and the video call can then be cleared.

1. A mobile telephone having a camera function, with the mobile telephone being designed such that, when a voice link exists between the mobile telephone and a remote station of another telephone subscriber, a camera photograph of an image is taken, controlled by the operation of at least one predetermined control element on the telephone, and the photographed image is sent wirelessly to a destination address, which is associated with the other telephone subscriber and is determined on the basis of the telephone number used for the voice link to the other telephone subscriber.

2. The mobile telephone as claimed in claim 1, wherein the mobile telephone is designed to send the photographed image to the destination address while the voice link exists by means of a dispatch service for multimedia messages or by means of an E-mail service, and in this case to use the telephone number used for the voice link to the other telephone subscriber as the destination address for the multimedia message dispatch, or to use an E-mail address which is stored in an internal telephone directory in the telephone, associated with the telephone number used for the other telephone subscriber, for the E-mail dispatch.

3. The mobile telephone as claimed in claim 1, wherein the mobile telephone is designed to display a viewfinder image in a display window while a voice link exists.

4. The mobile telephone as claimed in claim 1, wherein the mobile telephone is designed to automatically display on a display apparatus a multimedia message which has been received from the remote station while the voice link was in existence.

5. A mobile telephone having a video call camera function, with the mobile telephone being designed:
(i) in response to a voice call request entered by a user, to set up both a voice call and a video call to a destination telephone number predetermined by the voice call request,
(ii) to receive information sent back from a remote station associated with the destination telephone number, in response to the voice call and video call, and to confirm the availability of the remote station for voice links and/or video telephone links on the basis of the received information,
(iii) to clear the video call again,
(iv) during the existence of a voice link which has been produced by acceptance of the voice call by the remote station, to set up a further video call to the destination telephone number in response to a predetermined user input, and
(v) to clear the voice link in response to the acceptance of the further video call by the remote station.

6. The mobile telephone as claimed in claim 5, wherein the mobile telephone is designed to clear the video call without waiting for acceptance of the video call by the remote station.

7. The mobile telephone as claimed in claim 5, wherein the mobile telephone is designed to wait for acceptance of one of the two calls by the remote station, to clear the video call in response to acceptance of the voice call, and to clear the voice call in response to acceptance of the video call.

8. The mobile telephone as claimed in claim 5, wherein the mobile telephone is designed to display a menu option in a display window on the mobile telephone when a voice link exists, which menu option allows a change from the voice link to a video telephone link, with the menu option preferably being displayed as a function of the availability of the remote station for video telephone links having been confirmed.

9. The mobile telephone as claimed in claim 5, wherein the mobile telephone is designed to set up a further voice call to the destination telephone number, in response to a predetermined user input, during the existence of a video telephone link to the remote station, and to clear the video telephone link in response to the acceptance of the further voice call by the remote station.

10. The mobile telephone as claimed in claim 2, wherein the mobile telephone is designed to display a viewfinder image in a display window while a voice link exists.

11. The mobile telephone as claimed in claim 2, wherein the mobile telephone is designed to automatically display on a display apparatus a multimedia message which has been received from the remote station while the voice link was in existence.

12. The mobile telephone as claimed in claim 6, wherein the mobile telephone is designed to display a menu option in a display window on the mobile telephone when a voice link exists, which menu option allows a change from the voice link to a video telephone link, with the menu option preferably being displayed as a function of the availability of the remote station for video telephone links having been confirmed.

13. The mobile telephone as claimed in claim 7, wherein the mobile telephone is designed to display a menu option in a display window on the mobile telephone when a voice link exists, which menu option allows a change from the voice link to a video telephone link, with the menu option preferably being displayed as a function of the availability of the remote station for video telephone links having been confirmed.

14. The mobile telephone as claimed in claim 6, wherein the mobile telephone is designed to set up a further voice call to the destination telephone number, in response to a predetermined user input, during the existence of a video telephone link to the remote station, and to clear the video telephone link in response to the acceptance of the further voice call by the remote station.

15. The mobile telephone as claimed in claim 7, wherein the mobile telephone is designed to set up a further voice call to the destination telephone number, in response to a predetermined user input, during the existence of a video telephone link to the remote station, and to clear the video telephone link in response to the acceptance of the further voice call by the remote station.

16. The mobile telephone as claimed in claim 8, wherein the mobile telephone is designed to set up a further voice call to the destination telephone number, in response to a predetermined user input, during the existence of a video telephone link to the remote station, and to clear the video telephone link in response to the acceptance of the further voice call by the remote station.
